(19) United States
(12) Patent Application Publication
(10) Pub. No.: US 2007/0055623 A1
(43) Pub. Date: Mar. 8, 2007

(54) System and method for providing partial payment in the electronic commerce

(76) Inventors: Jung Soo Ha, Seoul (KR); Seung Hyun Lee, Seoul (KR); Woo Sung Lee, Seoul (KR)

Correspondence Address: MCDERMOTT WILL & EMERY LLP, 600 13TH STREET, N.W., WASHINGTON, DC, 20005-3096, US

(21) Appl. No.: 10/576,339

(22) PCT Filed: Oct. 16, 2004
(86) PCT No.: PCT/KR04/02656

§ 371 Date: Apr. 18, 2006

(30) Foreign Application Priority Data
Oct. 18, 2003 (KR) 10-2003-0072756

(51) Int. Cl. G06Q 40/00

(52) U.S. Cl. 705/39

(57) ABSTRACT

The present invention relates to a method and system for providing a partial payment in the electronic commerce via the Internet. More particularly, the present invention relates to the present invention relates to a method and system which can more simplify procedures of payment when a user makes a payment with a plurality of payment means or when the user cancels a payment partially, changes a payment means, or changes goods.

### TECHNICAL FIELD

The present invention relates to a method and system for providing a partial payment in the electronic commerce. More particularly, the present invention relates to a method and system which can more simplify procedures of payment when a user makes a payment with a plurality of payment means or when the user cancels a payment partially, changes a payment means, or changes goods.

### BACKGROUND ART

Today, rapid developments in the filed of a computer and a communication network such as the Internet have brought a great change in conventional commercial transactions. Not a way that a buyer goes to a store oneself, checks and purchases goods, the electronic commerce using the Internet and a computer system is being carried out popularly.

FIG. 1 illustrates configuration of a network for performing the electronic commerce via the Internet. As illustrated in FIG. 1, a seller provides buyers with information on a plurality of goods via server computers 140 and 150. Buyers collect or read information on goods by connecting to the server computer of a shopping mall via a communication network such as the Internet, using devices 110, 120 and 130 such as a PC, a mobile phone, or a PDA. A request for purchase of goods and payment thereof are performed via the Internet and servers 140 and 160.

As the electronic commerce using the Internet becomes popular, kinds of goods transacted on the Internet become various, such as for example, books, electronic home appliances, clothes, movies tickets, music, etc, and amounts of transactions become incredibly enormous. Accordingly, an amount of money that a customer has to pay at a time increases.

There are provided various methods using cash, a credit card, a mobile phone and the like, as a payment means used in the electronic commerce. In the conventional payment method, a user selects one payment method and makes a payment based on the selected payment method.

However, there is a problem that in case the user wants to pay with cash and credit card due to one's own necessity, the user cannot use one method with the other in the conventional payment method.

Furthermore, there is another problem that in case the user wants to purchase highly-priced goods and pay with a credit card, the user has to pay only by cash because an amount of money exceeds limit of the credit card and it becomes impossible to pay therewith.

Furthermore, in case of goods providing services continuously during a predetermined contract period, the user cannot cancel a payment corresponding to the rest period subtracting the service-sold period. Therefore, there is another problem that the user has to cancel a payment with respect to the entire contract period, which is already paid, and then has to make an additional payment with respect to the service-sold period.

Furthermore, as for another problem, there is inconvenience in the aspect that in case that the user completes a payment of specified goods using a credit card and purchases another goods in a change with the specified goods for some reasons, the user has to cancel the already-completed credit card payment and make an additional payment for the changed goods. In this case, if it is possible to make an additional payment or additional cancellation only for the difference between the first purchased goods and later purchased goods, procedures of payment can be more simplified.

Furthermore, there is inconvenience in the aspect that in case that the user has completed a payment using a predetermined payment means and later wants to make a payment in change with another payment means, the user has to newly perform a payment with a new payment means after canceling a payment by a first payment means.

Consequently, there has been desired for an advent of a new payment method and system which can improve the conventional payment method more remarkably in the electronic commerce via the Internet.

### BRIEF DESCRIPTION OF THE DRAWINGS

FIG. 1 is a configuration diagram illustrating configuration of a network for performing the electronic commerce via the Internet.

FIG. 2 is a flowchart illustrating a method for providing a partial payment in the electronic commerce via the Internet, according to the present invention.

FIG. 3 is a drawing illustrating one example of a screen displaying information on purchase particulars transmitted to a user, according to one embodiment of the present invention.

FIGS. 4a and 4b are drawings illustrating one example of a screen displaying information on payment means provided for a user.

FIG. 5a is a drawing illustrating one example of a screen for receiving credit card information from a user.

FIG. 5b is a drawing illustrating one example of a screen for transmitting account information to a user.

FIGS. 6a and 6b are drawings respectively illustrating examples of screens for providing result information of performed payment with respect to success of payment and failure thereof.

FIG. 7 is a drawing illustrating one example of a table showing billing particulars.

FIGS. 8a to 8d are drawings illustrating a change of a transaction table in performing a partial payment.

FIG. 9 is a flowchart illustrating a method for providing a partial payment for partial payment cancellation, in case there is a request for purchase cancellation, according to the present invention.

FIG. 10 is a drawing illustrating a change of a transaction table in performing partial payment cancellation.

FIG. 11 is a flowchart illustrating a method for providing a partial payment for an additional payment in changing goods according to the present invention.

FIGS. 12a to 12c are drawings illustrating a change of a transaction table for an additional payment in changing goods according to the present invention.

FIGS. 13a to 13b are drawings illustrating a change of a transaction table in changing a payment mean according to the present invention.

FIG. 14 is a block diagram illustrating internal configuration of a system for providing a partial payment in the electronic commerce via the Internet according to the present invention.

FIG. 15 is an internal block diagram of a general-purpose computer which can be adopted in a system for providing a partial payment in the electronic commerce via the Internet according to the present invention.

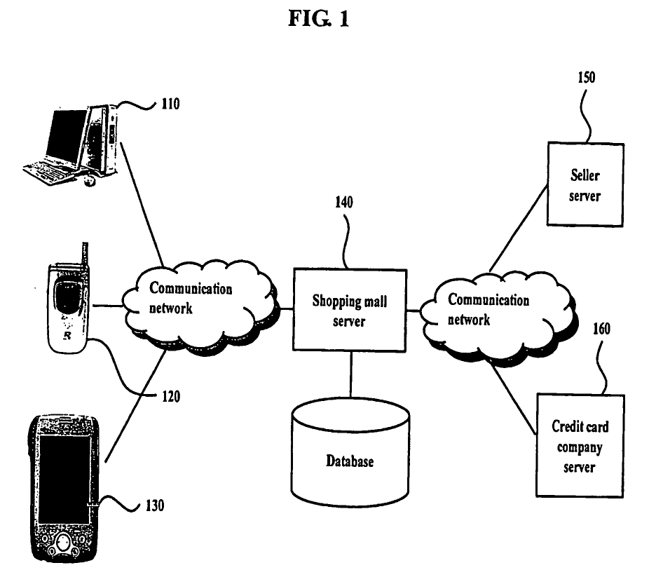

### DISCLOSURE OF THE INVENTION

Technical Questions

One object of the present invention is to seek convenience of a user by providing various forms of payment means in the electronic commerce via the Internet.

Another object of the present invention is to enable a credit cart payment, even in case an amount of money exceeds limit of credit card.

Another object of the present invention is to facilitate procedures of refund by enabling payment cancellation only for a partial payment.

Another object of the present invention is to facilitate a payment for the difference between two goods, caused by a change of goods.

An ultimate object of the present invention is to activate the electronic commerce via the Internet.

Technical Solutions

According to one aspect of the present invention, there is provided a method for providing a partial payment in the electronic commerce via the Internet, comprising the steps of receiving request information for purchase of goods from a user; in response thereto, transmitting information on purchase particulars related to said goods to the user; transmitting payment means information including a plurality of payment means to the user; receiving selection information on at least two payment means from the user; performing a partial payment, based on the selection information; transmitting result information of the performed payment to the user; and transmitting request information for sale of said goods based on said result information of the performed payment.

According to another aspect of the present invention, there is provided a method for providing a partial payment in the electronic commerce via the Internet, comprising the steps of receiving request information for purchase of goods from a user; in response thereto, transmitting information on purchase particulars related to said goods to the user; performing a payment for said goods; receiving purchase cancellation information from the user; calculating a refund based on said information on the purchase particulars; and performing partial payment cancellation in association with said refund.

### BEST MODE FOR CARRYING OUT THE INVENTION

Hereinafter, the present invention will be in detail described with reference to the accompanying drawings.

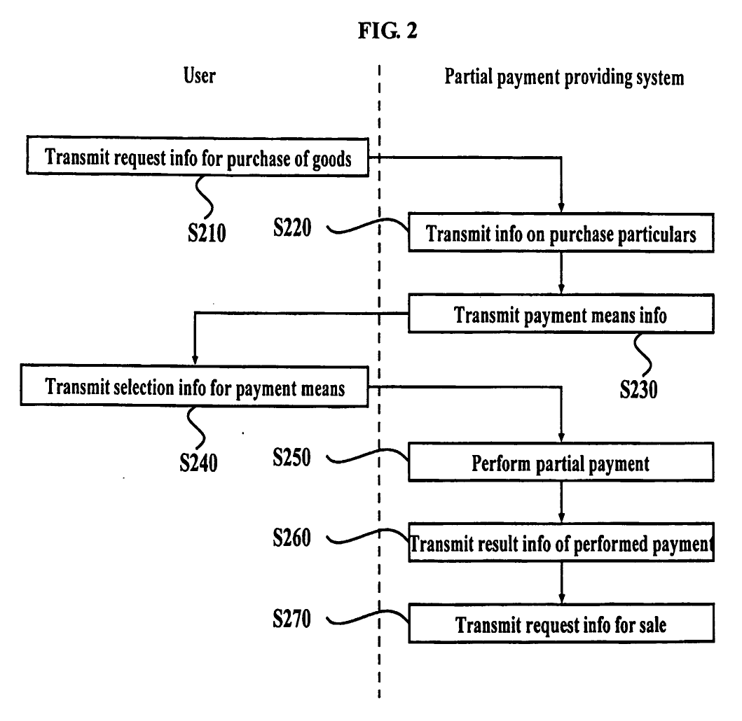

FIG. 2 is a flowchart illustrating a method for providing a partial payment in the electronic commerce via the Internet according to the present invention.

First, request information for purchase of goods is received from a user in S210. According to the present invention, an Internet shopping mall provides information on various goods for the user and the user can indicate one's purchase intention by transmitting purchase request information with respect to one's desired goods, based on the information on goods.

Request information for purchase of goods includes identification information (a name of goods) on goods that the user wants to purchase, and may further include the user's personal information such as a name, a resident registration number, an address, and the like. As for one embodiment, in case that the user is enabled to participate in procedures of purchase only by receiving log-in information (e.g., an ID and a password) and completing a procedure of log-in, it may be possible to omit a procedure of receiving separate personal information as request information for purchase of goods.

In the next, in response to request information for purchase of goods received in S210, information on purchase particulars related to the goods are transmitted to the user in S220.

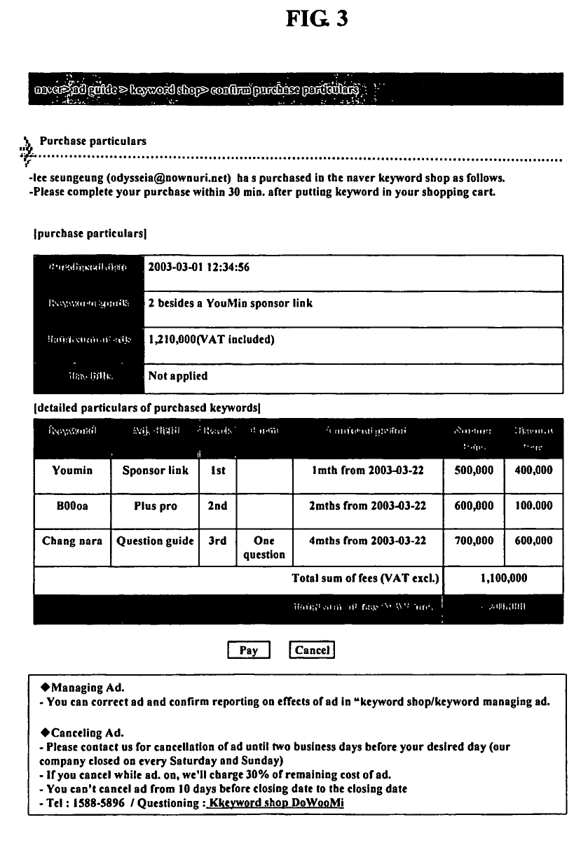

Information on purchase particulars may include information such as a purchased date, a name of goods, an amount of money, detailed purchase particulars and the like. FIG. 3 illustrates one example of a screen displaying information on purchase particulars transmitted to a user, in “keyword” goods providing a keyword advertisement related to a search result of a search engine, according to one embodiment of the present invention. Information on purchase particulars may include various forms of information additionally, based on kinds of goods. In case of goods providing services continuously during a predetermined contract period, information on purchase particulars may comprise “contract period” (in FIG. 3, a period for which a keyword purchased by a user is advertised) information. Moreover, information on purchase particulars may comprise a condition for purchase cancellation or refund information (charges) in case of purchase cancellation.

In S230, payment means information including a plurality of payment means is transmitted to the user.

According to the present invention, various forms of payment means are provided for the user, and the user can select any payment means from the plurality of payment means freely.

As for one example, a payment means may include at least one selected from a group consisting of cash, a credit card, and a mobile phone, which are most common payment means in today's electronic commerce. “A plurality of payment means” according to the present invention may include different payment means in plurals, such as for example, cash and a credit card, or may include credit card payment means through a plurality of different credit cards (e.g., credit cards with respectively different card numbers)

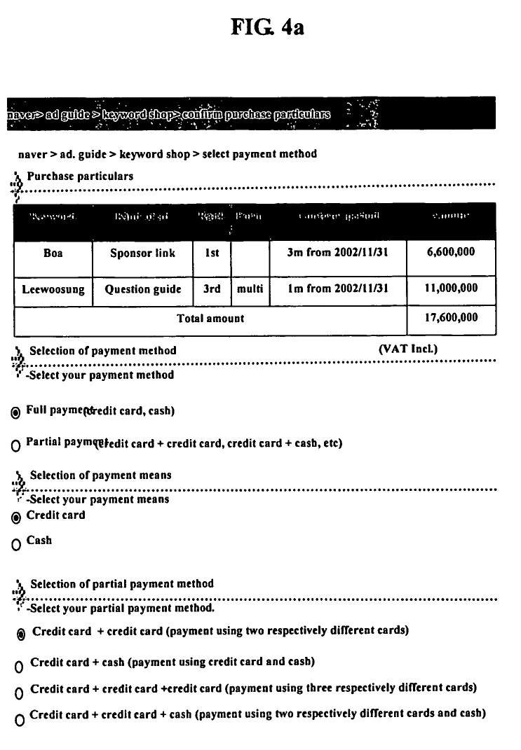

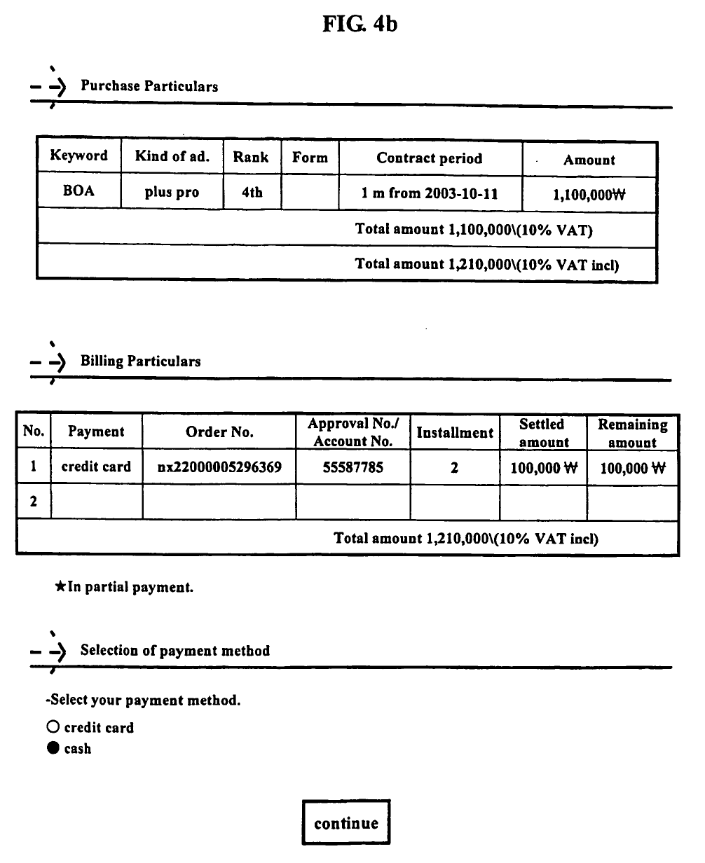

FIG. 4a illustrates one example of a screen displaying payment means information provided for a user. Although FIG. 4a illustrates an example of a credit card+a credit card and a credit card+cash, there may be provided various forms of payment means such as a credit card+a credit card+a credit card, a credit card+a credit card+cash and the like.

FIG. 4b illustrates another example of a screen displaying payment means information. As illustrated in FIG. 4b, payment means information displays not only kinds of payment means, but also a settled amount of money and a remaining amount of money.

Like above, according to the present invention, there is an effect that limit of a credit card increases by enabling a partial payment using a plurality of credit cards. Therefore, even in case of purchasing highly-priced goods exceeding limit of one credit card, it becomes possible to avoid inconvenience in the prior art, in which the user can pay only by cash and cannot use a credit card. For example, if the user uses three credit cards of which limit is respectively 6,000,000 won, total limit of three credit cards rises up to the maximum 18,000,000 won.

Selection information on payment means is received from the user in S240. The user selects at least two payment means for a partial payment and transmits selection information as a selection result. Selection information includes information on kinds of payment means that the user has selected.

As for one example, the present invention may limit the number of credit cards that the user selects as a plurality of payment means, below a predetermined number (e.g., below 5). This is to prevent procedures of payment from being delayed intentionally in a way that an ill-willed user performs a partial payment using excessively many credit cards for a small amount of money.

In the next, a partial payment is performed in S250, based on selection information received in S240. In S250, a payment can be performed sequentially for at least two payment means that the user has selected.

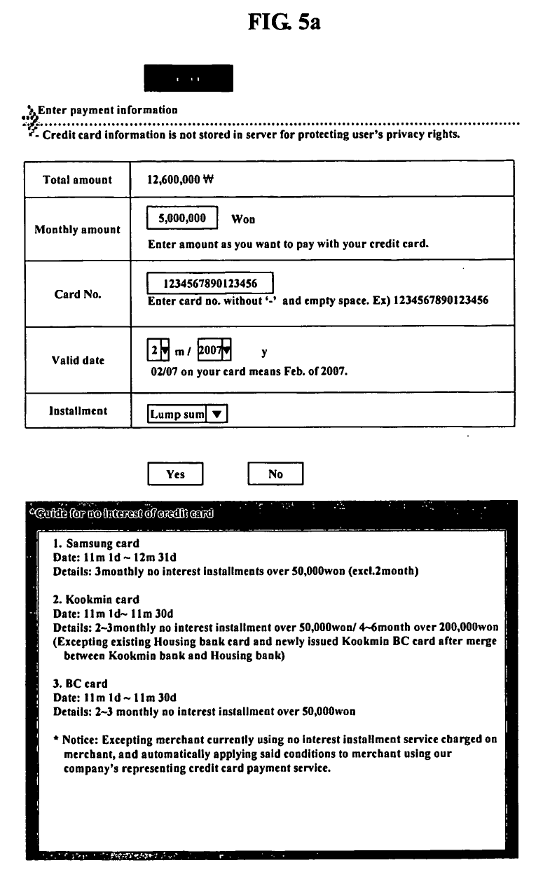

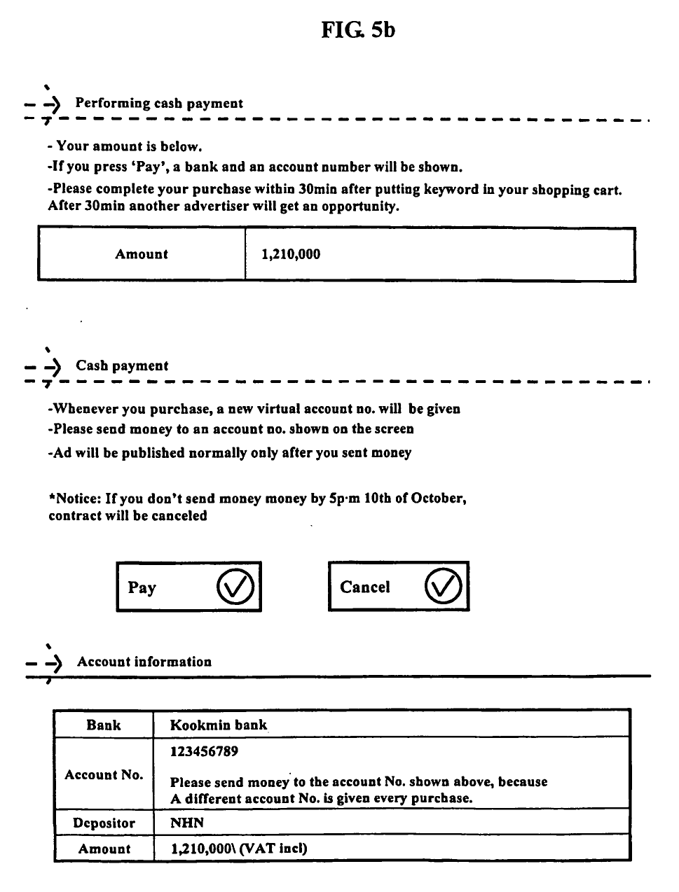

In case that a credit card is included in payment means of selection information input by the user, the step of performing a partial payment may further comprise the steps of receiving credit card information from the user, wherein the credit card information includes a kind of credit card, a credit card number, and a valid date; and transmitting the credit card information to a server of a credit card company and asking for payment approval. FIG. 5a illustrates one example of a screen for receiving credit card information from the user.

Moreover, in case that cash payment is included in payment means of selection information input by the user, the step of performing a partial payment may further comprise the steps of transmitting account information to the user, wherein the account information includes an account number and a depositor; and confirming receipt of money related to the account. As for one example, information on receipt of money may be received for confirmation thereof. FIG. 5b illustrates one example of a screen for transmitting account information to the user.

A virtual account may be used as one example of an account for a cash payment. At this time, the virtual account has a different account number every cash payment and pre-holds information on an amount of money. Therefore, even in case that the user sends more money or less money than an amount of money, it is possible to perform confirmation on receipt of money easily.

In S260, result information for a partial payment performed in S250 is transmitted to the user.

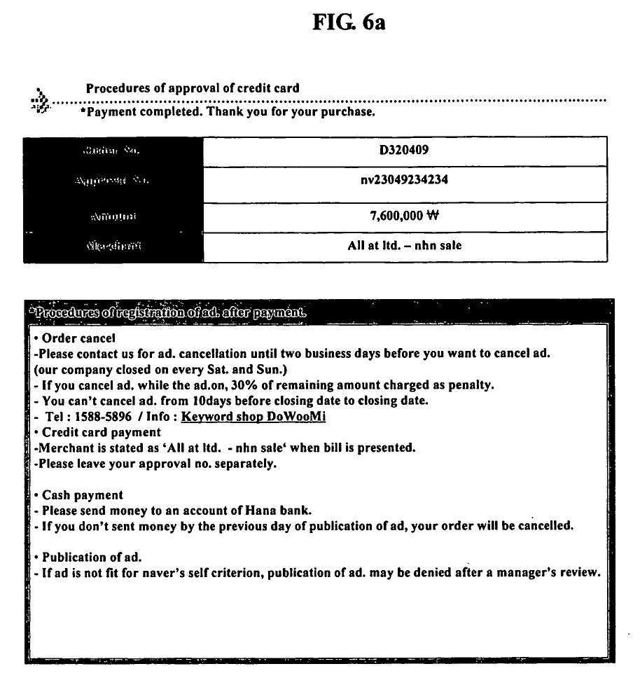

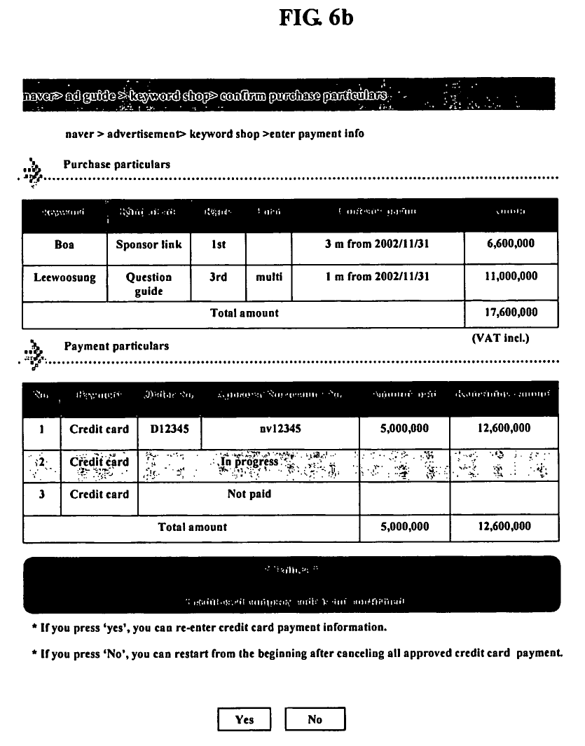

As for one example of result information of the performed payment, in case that credit card payment is successfully completed by receiving payment approval, or in case that confirmation information on receipt of money is received for cash payment, information indicating a success of payment may be received. On the contrary, in case that payment denial is received for the credit card payment, information indicating a failure of payment may be received. FIGS. 6a and 6b respectively illustrate examples of screens displaying result information of the performed payment with respect to success of payment and failure thereof.

Finally, request information for sale is transmitted in S270, based on result information of the performed payment. In case that a payment is completed successfully, the user asks for sale of goods, for which request information for sale may be transmitted. Request information for sale of goods may include identification information on goods (a name of goods), detailed particulars thereof, user information and the like. Only in case that request information for sale is transmitted, it is determined that goods will be actually provided for the user. Therefore, goods will be actually delivered to the user or services will be provided for the user, based on transmission of sale request information.

As for one example of the present invention, a method for providing a partial payment via the Internet according to the present invention allows a partial payment only in case that an amount of money exceeds a predetermined value. Namely, in case that a partial payment is allowed even in case of an excessively small amount of money, it is not preferable since an operator of a shopping mall has to spend much time and efforts in procedures of payment. Therefore, it becomes possible to prevent an ineffective procedure of payment by allowing a partial payment only in case that an amount of money exceeds the predetermined value.

As for another example of the present invention, in case that cash payment is included in selection information on a plurality of payment means received from the user, it is preferable to transmit request information for sale of goods after confirming that the user has sent money (receiving information on receipt of money). This is because, in case of cash payment, only in case that receipt of money is completed, a payment is regarded as success thereof. This is different from the credit card payment.

The present invention embodies new technical ideas, which are different in the prior art, in providing a partial payment using a plurality of payment means. This is attributed to a generation of a transaction table, a change thereof and a correction thereof using introduction of a session variable.

Hereinafter, a change of a transaction table will be in detail described using a session variable.

Whenever a procedure of payment is performed in an Internet shopping mall, information on procedures of payment is stored in the transaction table and maintained therein. Whenever one payment activity is performed, the transaction table adds entry information, wherein each of entry information may comprise a paid order number, a key for indicating particulars of paid goods, information on an amount of money, a key for indicating a payment state, paid sequence and information on the number of partial payments. The paid order number means a key capable for recognizing particulars approved by the credit card company. The key for indicating particulars of paid goods means a key (indicating number) capable for connecting a table of particulars of paid goods, in which the table includes detailed information on paid goods. As the key for indicating a payment state indicates a state with respect to a procedure of payment, the key may include any one of “receipt of money completed”, “a request for refund”, “refund completed”, “a request for cancellation”, “cancellation completed”, “a cash-based contract” or the like.

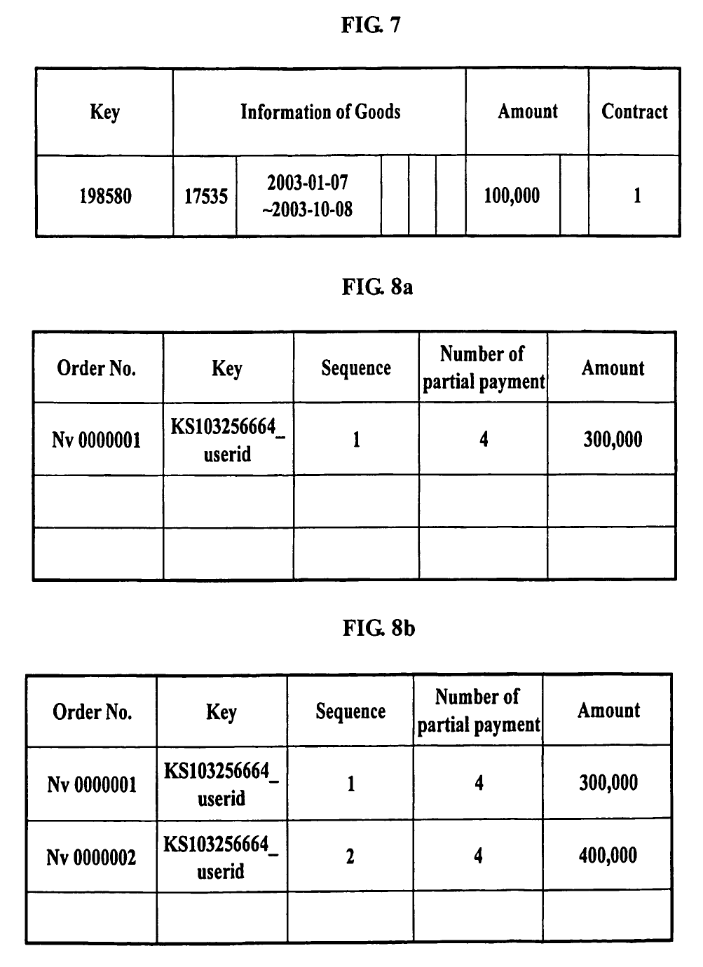

Moreover, as each table of particulars of paid goods exists per every goods with respect to paid goods, payment particulars are stored by goods purchased by the user. FIG. 7 illustrates one example of a table of particulars of paid goods. As illustrated in FIG. 7, the table may comprise a key for indicating particulars of paid goods, goods information, price information, and information on a contract state. The goods information may comprise a name of goods, a contract period, a form of goods and the like. The price information may comprise information on normal price of goods, selling price, discount price, and the like. And the contract state may comprise information on a current state of corresponding goods, such as a request of sale, sale completed, sale cancelled and the like.

A conventional payment method enters a post value directly into the transaction table and the table of particulars of paid goods, wherein the post value is a value carried over from a previous page to a front page of a screen provided in a procedure of payment. Therefore, if a payment is successful, information related thereto is spontaneously input into the transaction table and the table of particulars of paid goods. This is to secure perfection between the transaction and particulars of paid goods.

Namely, according to the prior art, there is no more change of information in the transaction table wherein the information is input once. Therefore, in case that there is a change in contents of payment such as payment cancellation (refund), a change of payment means, a change of goods and a combination sale, there is no way to newly input the changed information into the transaction table, in connection with the existing payment information.

However, the present invention enables a change of information in the transaction table as desired by using a session variable.

The session variable is a value temporarily stored in a shopping mall server and always maintained on the same window while the server is connected with a web-browser of the user's device. Therefore, according to the present invention, when particulars of goods are input into the table of particulars of paid goods in success of a partial payment, the key for indicating particulars of paid goods paid is temporarily stored in the server using the session variable, wherein the user's web browser is always maintained in performing the procedure of payment.

Accordingly, it should be determined whether or not there is the key for indicating particulars of paid goods in performing a partial payment later. In case that there is the key, there is no need to input payment information into the table of particulars of paid goods. Hereby, double input of the same goods is prevented even in performing a partial payment and double payment is also prevented by using characteristics of the session variable, the only key.

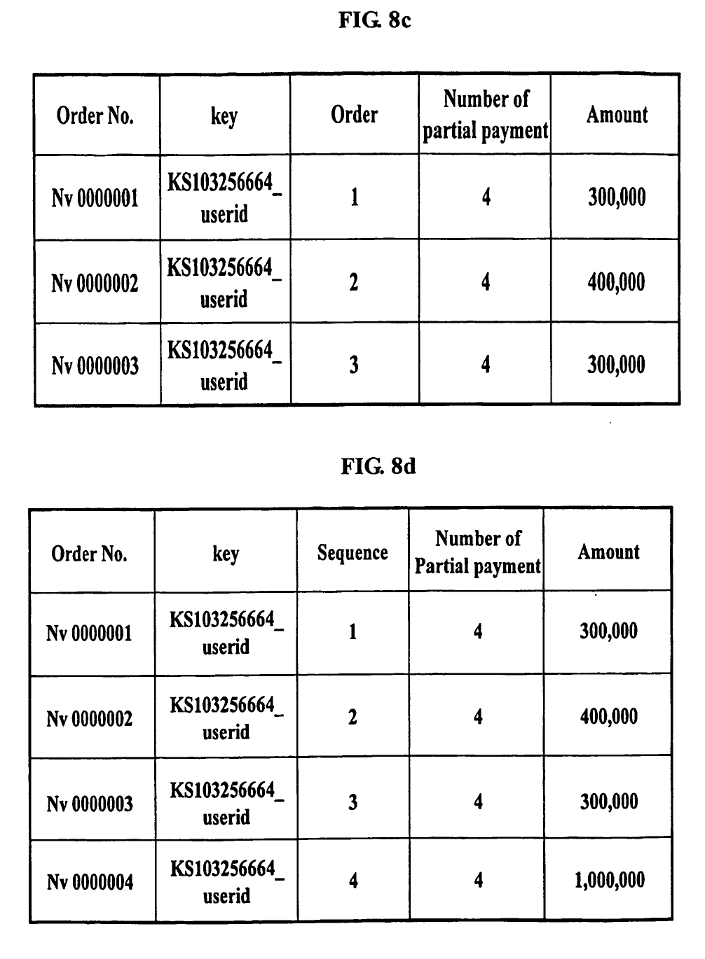

Disclosed is a change of the transaction table in performing a partial payment. In case that the user purchases predetermined goods and pays four monthly payments for 2,000,000 won, FIGS. 8a to 8d illustrate each change of the transaction table in each step of partial payments. Whenever each of partial payments succeeds, new entry is generated in the transaction table and payment sequence increases 1 by 1. When a payment sequence value increased with success of each payment, becomes 4 as same to the total number of partial payments, the entire payment is regarded to have been completed.

The aforementioned embodiments have in detail described a procedure which enables the user to perform a partial payment using a plurality of payment means. A method for providing a partial payment according to the present invention provides various embodiments with respect to partial payment cancellation, an additional payment in changing goods or a change of payment means, besides provision of the plurality of payment means. Hereinafter, other embodiment with respect to a partial payment will be in detail described.

As for another embodiment, the present invention may receive a request for purchase cancellation from the user and perform partial payment cancellation in refunding in connection with the purchase cancellation.

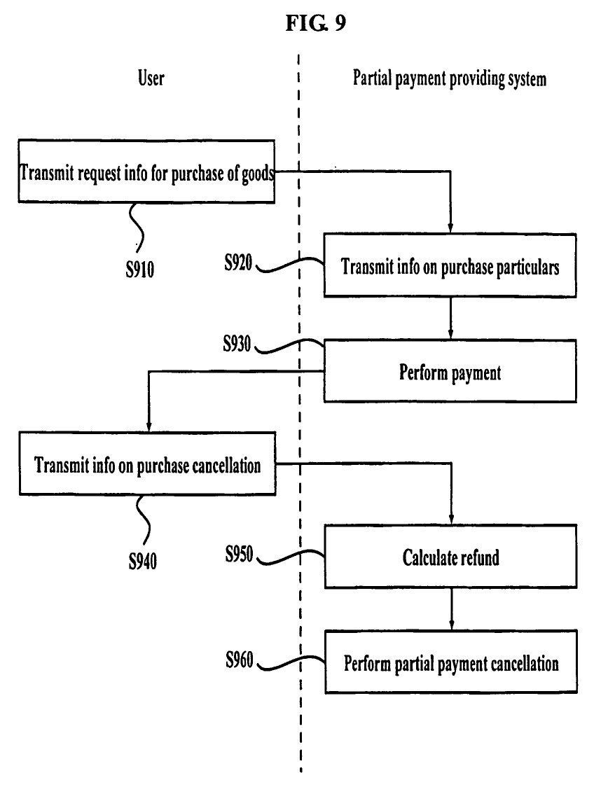

FIG. 9 is a flowchart illustrating a method for providing a partial payment for partial payment cancellation, in case that there is a request for purchase cancellation according to the present invention. Hereinafter, procedures performed in each step will be in detail described with reference to FIG. 9.

First, request information for purchase of goods is received from the user in S910 and, in response thereto, information on purchase particulars related to the goods are transmitted to the user. Receipt of purchase request information and transmission of information on purchase particulars have been in detail described in S210 and S220 of FIG. 2. The same may be applied to S910 and S920 in FIG. 9.

In the next, a payment for the goods is performed in S930. Payment means information including one or at least two payment means may be transmitted to perform a payment. At this time, a procedure of payment is performed using the payment means. The procedure of payment in S930 includes a procedure of generating the transaction table, which has been in detail described in the previous embodiments. Therefore, more detailed explanation thereto will be omitted in S930.

Purchase cancellation information is received from the user in S940. The user can freely indicate one's intention, purchase cancellation, by transmitting purchase cancellation information with respect to goods for which payment has been completed. The purchase cancellation information may further comprise purchase information (purchased date, an amount of money), besides identification information (a name of goods) with respect to goods.

In response to the received purchase cancellation, an amount of money that is to be refunded to the user is calculated in S950. As for one example, information on purchase particulars transmitted to the user can be referred in calculating a refund. Information on purchase particulars may comprise a purchased date, an amount of money, a contract period, a condition for purchase cancellation and refund information in canceling the purchase. Based on information on purchase particulars, a refund can be decided.

On one hand, in case of goods whose sale is completed as one activity (e.g., the sale of electronics), a refund will be set same to an amount of money paid at the first or as an amount of money from which charges are subtracted.

On the other hand, in case of goods whose sale is continuously provided during a predetermined contract period (e.g., keyword goods for providing keyword advertisement), it is more preferable to calculate an amount of money from which a predetermined amount of money is subtracted, as a refund. At this time, the predetermined amount of money corresponds to the period from when the user purchased the goods to when the user asks for purchase cancellation. For example, if a request for purchase cancellation is received one month after a total amount of 900,000 won has been settled in connection with a keyword advertisement to be published during the three-month contract period, a refund may be calculated as 600,000 won or as 570,000 won after additionally subtracting 30,000 won as charges. Like above, it is possible to calculate a refund based on information on purchase particulars in S950.

For example, S950 may comprise the step of calculating a refund, generating refund information related to the refund and transmitting the generated refund information to the user. The refund information may include information on how much to refund and how to refund.

In S960, partial payment cancellation is performed in association with the refund.

In order to cancel a payment, a request for cancellation of approval may be performed with respect to a credit card payment and a request for cancellation of issuance of a virtual account may be performed with respect to a cash payment.

A method for providing a partial payment according to the present invention performs partial payment cancellation, wherein partial payment cancellation is performed in association with a partial amount of money in canceling a payment. In case that a payment is performed using a plurality of payment means, payment means to perform payment cancellation is selected and partial payment cancellation can be selectively performed with respect to the selected payment means, based on an amount of money for each payment means.

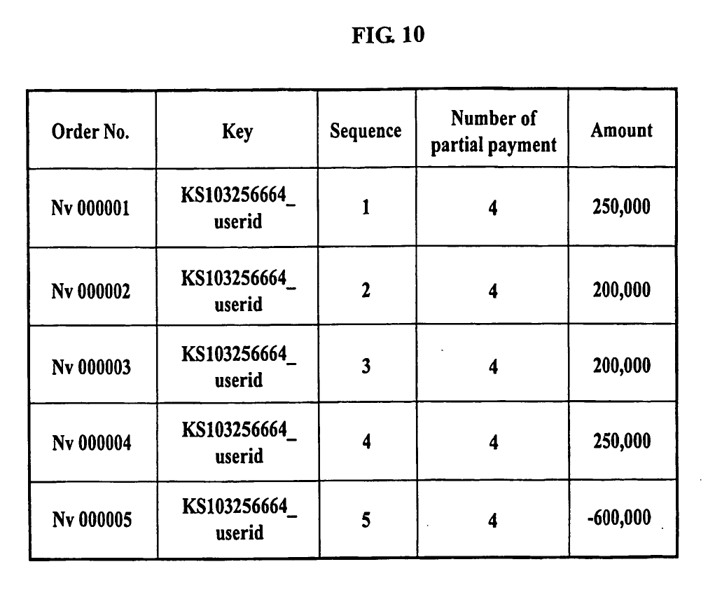

Partial payment cancellation brings a change of the transaction table. Hereinafter, a change of the transaction table will be in detail described. FIG. 10 illustrates a change of the transaction table in case that 600,000 won is calculated as a refund with respect to an amount of money, 900,000 won and partial payment cancellation is performed with respect to the calculated refund. As shown in FIG. 10, while new entry for an amount of money, −600,000 won is generated in the transaction table, there is a change thereof for partial payment cancellation. As for one example, as new entry for a minus amount of money (amount of money to be cancelled) is added to the transaction table, payment sequence increases to “5,” but there is no change in the number of partial payments. In addition, the key for indicating a payment state of entry with respect to a minus amount of money changes into “state of a request for cancellation” and if payment cancellation is completed, the key for indicating a payment state of newly added entry for a minus amount of money changes into “state of cancellation completed”.

As for another example, it may be possible to perform an additional payment easily by adopting a partial payment method according to the present invention, even in changing goods.

Namely, in case that the user first completes a payment with respect to predetermined goods using a credit card and wants to change the same with another goods for some reason, procedures of payment may be more simplified, if possible, by additionally paying or canceling the difference between goods that the user has initially purchased (hereinafter, “initially-purchased goods”) and goods that the user wants to purchase in change for initially-purchased goods (hereinafter, “changed goods”), rather than by canceling a total amount of money for the initially-purchased goods and newly performing a payment for the changed goods.

FIG. 11 is a flowchart illustrating a method for providing a partial payment for an additional payment in changing goods, according to the present invention. Hereinafter, procedures performed in each step will be in detail described with reference to FIG. 11.

First, purchase request information for initially-purchased goods is received from the user in S1110 and, in response thereto, information on purchase particulars related to the initially-purchased goods is transmitted to the user in S1120. Receipt of purchase request information and transmission of purchase particulars have been in detail described in S210 and S220 of FIG. 2. The same may be applied to S1110 and S1120 in FIG. 11. Information on purchase particulars may further include information such as a condition for change and charges thereof in changing goods.

In the next, a payment for the goods is performed in S1130. In order to perform a payment, payment means information including one or at least two payment means may be transmitted. A procedure of payment is performed by using the payment means. The procedure of payment in S1130 includes a procedure of generating the transaction table. Detailed descriptions thereto have been made in the preceded embodiments and will be omitted in this step.

Request information for change of goods is received in S1140. Request information for change of goods includes information on the initially-purchased goods and changed goods (price information or the like).

The difference between two goods is calculated in association with the request for change of goods in S1150. The difference between two goods may be calculated based on the difference in prices between initially-purchased goods and changed goods. In addition, charges may be an additional factor in calculating the difference in changing goods. In order to calculate the difference, information on purchase particulars or request information for change of goods may be referred.

An additional payment for the difference is performed in S1160. As for one example of an additional payment, if changed goods cost more than initially-purchased goods, an additional payment is performed for the difference. As for another example of an additional payment, if changed goods cost less than initially-purchased goods, payment cancellation is performed for the difference. Procedures of payment and partial payment cancellation described in the preceded embodiments may be applied to those of payment and payment cancellation for the difference.

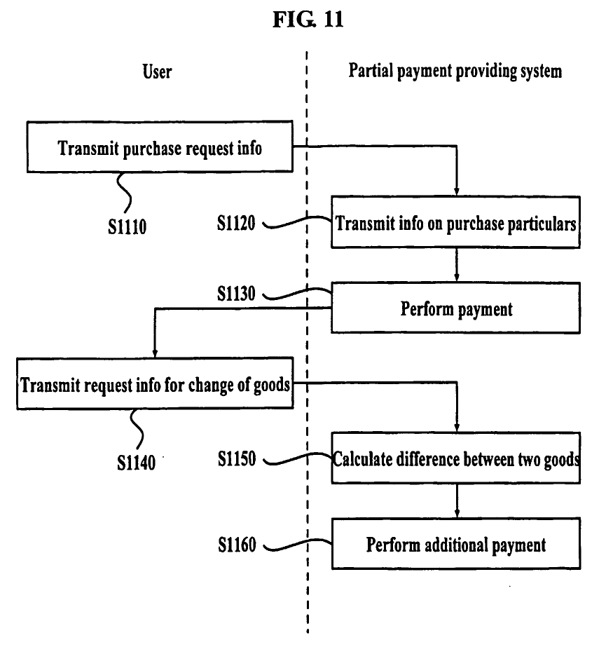

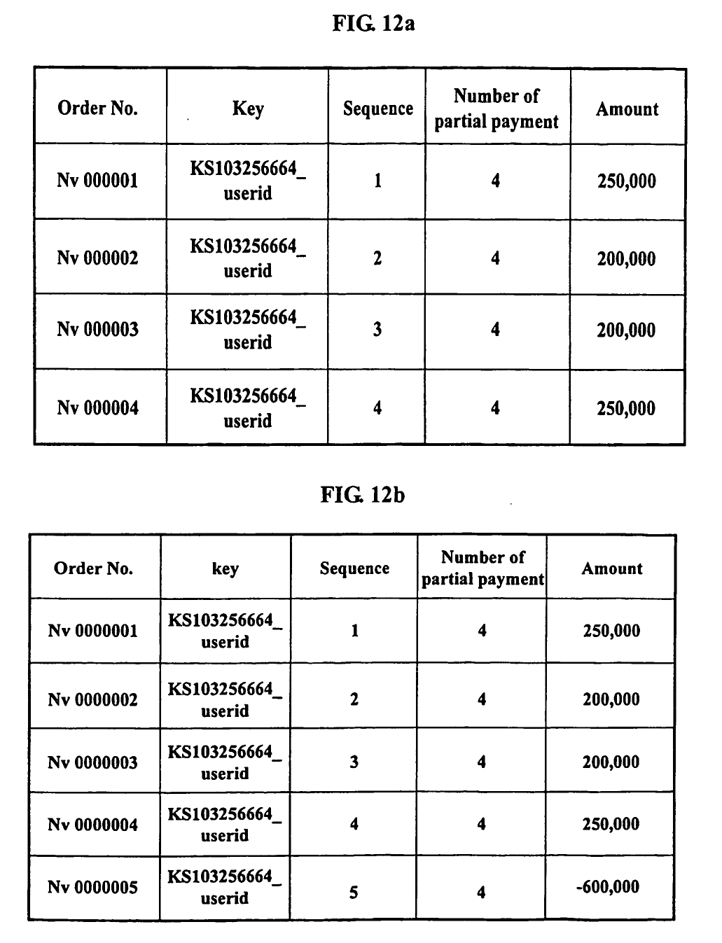

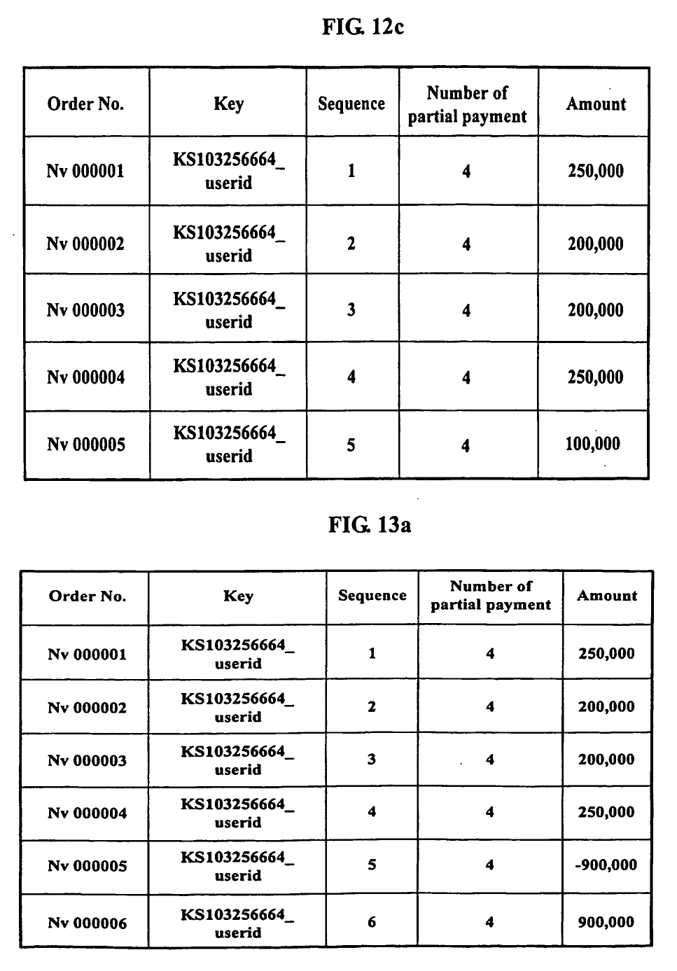

A procedure of an additional payment accompanies a change of the transaction table. FIGS. 12a to 12c illustrate a change of the transaction table for an additional payment in changing goods according to the present invention. First, FIG. 12a illustrates the transaction table, wherein partial payments have been completed throughout four times with respect to an amount of money, 900,000 won (250,000 won+200,000 won+200,000 won+250,000 won) of initially-purchased goods. FIG. 12b illustrates a change of the transaction table, in case that an amount of money of changed goods is 300,000 won, wherein partial payment cancellation is performed while new entry is generated for the difference between two goods, −600,000 won. FIG. 12c illustrates a change of the transaction table, in case that an amount of money of the changed goods is 1,000,000 won, wherein an additional payment is performed while new entry is generated for the difference between two goods, 100,000 won.

As for another example, it is possible to perform a payment easily by adopting a partial payment method according to the present invention, even in changing payment means.

Namely, even in case that the user completes a payment using a predetermined payment means and wants to change the same with another payment means for some reason (e.g., a change of a payment means between cash and a credit card, or that from a Kookmin credit card to a Foreign Exchange credit card), the user may change a payment means easily through an addition of entry of the transaction table.

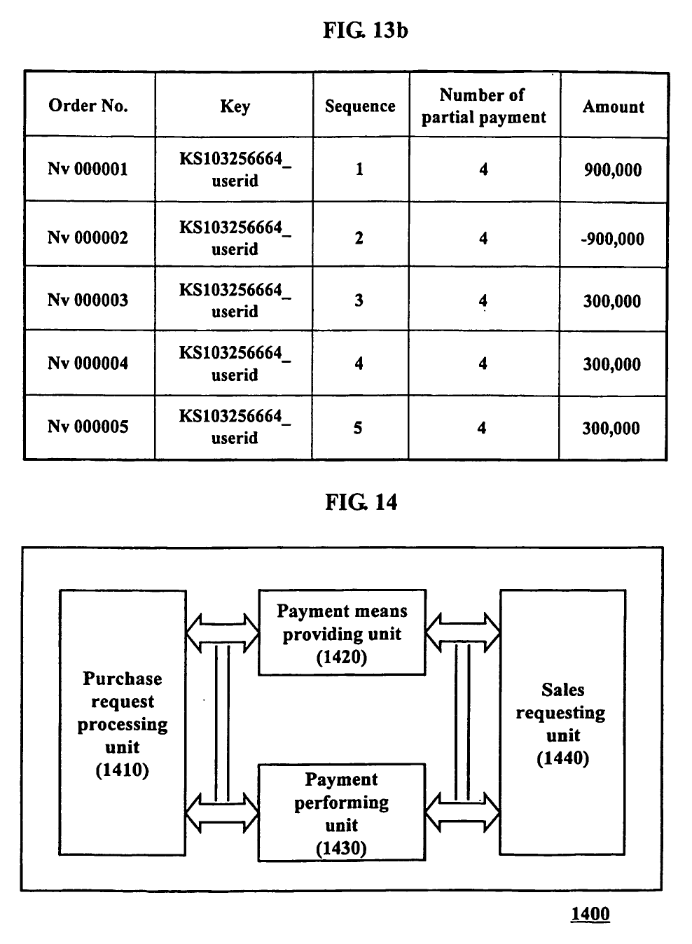

A change of a payment means accompanies a change of the transaction table. FIGS. 13a to 13b illustrate a change of the transaction table in changing a payment means.

As shown in FIG. 13a, in case that a payment means is changed with cash payment after four monthly partial payments have been performed using a credit card for an amount of money, 900,000 won, new entry is first generated for −900,000 won cancelled. In the next, while additional entry for cash payment of 900,000 won is generated, the key for indicating a payment state may indicate “a state of cash-based contract”.

Furthermore, as shown in FIG. 3b, in the sate where the user has not sent money (the key for indicating a payment state indicating “cash-based contract”) after making a contract to pay with cash for an amount of money, 900,000 won, it is possible for the user to make a partial payment using a credit card by changing a payment means. Namely, it is possible to perform a partial payment by completing payment cancellation for 900,000 won in the state of cash-based contract through generation of entry for −900,000 won and soon after, by generating additional entry using a credit card. Even in changing a payment means between credit cards, it is possible to perform a partial payment using a new credit card by canceling a payment in connection with a preceded credit card through generation of entry for a minus amount of money and by generating entry for partial payments using a separate window for an additional payment.

Namely, a method for providing a partial payment according to the present invention may further comprise the steps of receiving request information for payment means; in response thereto, canceling a payment via an initial payment means; and performing a payment via a changed payment means.

Like above, the present invention provides a partial payment via a plurality of payment means and embodies new technical ideas which are different in the prior art, in refunding (partial payment cancellation), changing goods, doing a combination sale, and changing a payment means. And this is attributed to a change of the transaction table using introduction of the session variable.

FIG. 14 is a block diagram illustrating internal configuration of a partial payment providing system 1400 in the electronic commerce via the Internet according to the present invention.

As shown in FIG. 14, the partial payment providing system 1400 comprises a purchase request processing unit 1410, a payment means providing unit 1420, a payment performing unit 1430 and a sale requesting unit 1440.

The purchase request processing unit 1410 receives request information for purchase of goods from the user and in response thereto, transmits information on purchase particulars related to the goods. The user can show one's purchase intention by transmitting request information for purchase of goods, wherein request information for purchase of goods may include identification information on goods and the user's personal information.

The payment means providing unit 1420 transmits payment means information including one or at least two payment means, to the user and receives selection information for at least two payment means from the user.

The payment performing unit 1430 performs a partial payment, based on the selection information and transmits result information of performed payment to the user. According to the present invention, in case that there is a request for purchase cancellation, partial payment cancellation may be performed. In addition, in case that there is a request for change of goods or payment means, a payment may be performed easily through a change of the transaction table. The payment performing unit 1430 performs a change of the transaction table according to an amount of money based on an additional payment and payment cancellation. Detailed descriptions with respect to a change of the transaction table have been described in preceded embodiments.

The sale requesting unit 1440 transmits request information for sale of the goods, based on result information of performed payment. In case that a payment was successful completed, request information for sale of goods is transmitted to a person in charge of sales so that goods may be delivered to the user. Sale request information may comprise identification information on goods, detailed particulars thereof, or the user information.

In addition, embodiments of the present invention further relate to computer readable media that include program instructions for performing various computer-implemented operations. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

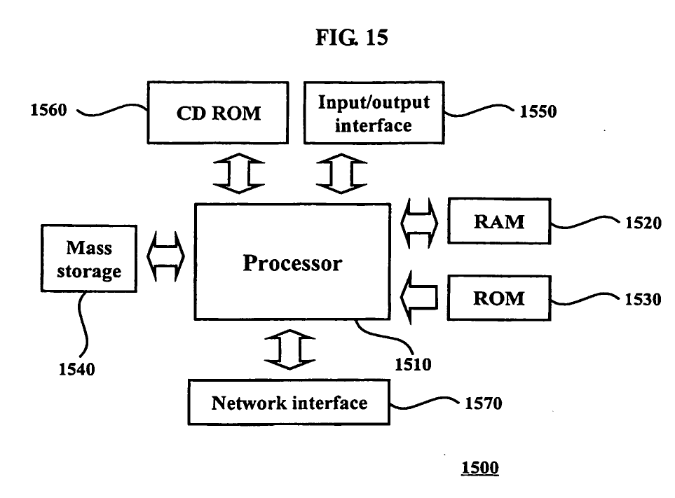

FIG. 15 is an internal block diagram of a general-purpose computer system which may be adopted in a system for providing a partial payment in the electronic commerce via the Internet according to the present invention.

The computer system 1500 includes any number of processors 1510 (also referred to as central processing units, or CPUs) that are coupled to storage devices including primary storage (typically a random access memory, or “RAM 1520”), primary storage (typically a read only memory, or “ROM 1530”). As is well known in the art, ROM 1530 acts to transfer data and instructions uni-directionally to the CPU and RAM 1520 is used typically to transfer data and instructions in a bi-directional manner. Both of these primary storage devices may include any suitable type of the computer-readable media described above. A mass storage device 1540 is also coupled bi-directionally to CPU and provides additional data storage capacity and may include any of the computer-readable media described above. The mass storage device 840 may be used to store programs, data and the like and is typically a secondary storage medium such as a hard disk that is slower than primary storage. A specific mass storage device such as a CD-ROM 1560 may also pass data uni-directionally to the CPU. Processor 1510 is also coupled to an interface 1550 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1510 optionally may be coupled to a computer or telecommunications network using a network connection as shown generally at a network interface 1570. With such a network connection, it is contemplated that the CPU might receive information from the network, or might output information to the network in the course of performing the above-described method steps. The above-described devices and materials will be familiar to those of skill in the computer hardware and software arts.

The hardware elements described above may be configured (usually temporarily) to act as one or more software modules for performing the operations of this invention.

Like above, the foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

### INDUSTRIAL APPLICABILITY

Like aforementioned, according to the present invention, there is an effect that it is possible to help the electronic commerce more activated by seeking convenience of a user, wherein there are provided various forms of payment means and a plurality of payment means.

According to the present invention, there is an effect that it is possible to enhance limit of credit card by enabling at least two credit cards to be used in paying goods.

According to the present invention, there is an effect that it is possible to facilitate a refund through a procedure of partial payment cancellation, even in refunding according to purchase cancellation.

According to the present invention, it is possible to simplify a change of goods by additionally paying or partially canceling the difference, even in case that the user wants to purchase other goods by changing fully settled goods therewith.

According to the present invention, it is possible to change a payment means without additional payment, even after having performed a payment using a predetermined payment means.

1. A method for providing a partial payment in the electronic commerce via the Internet, the method comprising the steps of:
receiving request information for purchase of goods from a user;
in response thereto, transmitting information on purchase particulars related to said goods to the user;
transmitting payment means information including a plurality of payment means to the user;
receiving selection information on at least two payment means from the user;
performing a partial payment, based on the selection information;
transmitting result information of the performed payment to the user; and
transmitting request information for sale of said goods based on said result information of the performed payment.

2. The method as claimed in claim 1, wherein said plurality of payment means comprise at least one selected from a group consisting of cash, a credit card and a mobile phone.

3. The method as claimed in claim 1, the method further comprising the steps of, in case that a cash payment is included in the selection information, transmitting account information to the user and receiving information on receipt of money related to the account,
wherein said request information for sale is transmitted after receiving the information on receipt of money.

4. The method as claimed in claim 1, wherein said plurality of payment means comprise at least two different credit cards.

5. The method as claimed in claim 1, wherein an amount of money related to purchase of said goods exceeds a predetermined value.

6. The method as claimed in claim 1, wherein said plurality of payment means comprise a plurality of credit cards and the number of the credit cards is restricted below a predetermined number.

7. A method for providing a partial payment in the electronic commerce via the Internet, the method comprising the steps of:
receiving request information for purchase of goods from a user;
in response thereto, transmitting information on purchase particulars related to said goods to the user;
as the step of performing a payment for said goods, generating a transaction table in association with said payment;
receiving purchase cancellation information from the user;
calculating a refund based on said information on the purchase particulars; and
performing partial payment cancellation in association with said refund;
wherein the step of performing partial payment cancellation adds entry information associated with said refund to the transaction table.

8. A method for providing a partial payment in the electronic commerce via the Internet, the method comprising the steps of:
receiving request information for purchase of goods from a user;
in response thereto, transmitting information on purchase particulars related to said goods to the user;
as the step of performing a payment for said goods, generating a transaction table in association with said payment;
receiving request information for change of goods from the user;
calculating a difference in an amount of payment, associated with said request information for change of goods; and
performing an additional payment for said difference;
wherein the step of performing an additional payment adds entry information associated with said difference to the transaction table.

9. The method as claimed in claim 7, wherein the transaction table includes a key for indicating particulars of goods, and said key for indicating particulars of goods is stored using a session variable.

10. A computer readable record medium recording a program for implementing a method according to claim 1.

11. A system for providing a partial payment in the electronic commerce via the Internet, the system comprising:
a purchase request processing unit for receiving request information for purchase of goods from a user and, in response thereto, transmitting information on purchase particulars related to said goods to the user;
a payment means providing unit for transmitting payment means information including a plurality of payment means to the user and receiving selection information on at least two payment means from the user;
a payment performing unit for performing a partial payment based on the selection information and transmitting result information of the performed payment to the user; and
a sale requesting unit for transmitting request information for sale of said goods based on said result information of the performed payment.

12. The method as claimed in claim 8, wherein the transaction table includes a key for indicating particulars of goods, and said key for indicating particulars of goods is stored using a session variable.
